(19) United States
(12) Patent Application Publication
(10) Pub. No.: US 2026/0291921 A1
(43) Pub. Date: Sep. 24, 2026

(54) SECURE MULTI-PARTY COMPUTATION SYSTEM AND OPERATING METHOD THEREOF

(71) Applicants: INVENTEC (PUDONG) TECHNOLOGY CORPORATION, Shanghai (CN); INVENTEC CORPORATION, Taipei City (TW)

(72) Inventors: Yu-Te KU, Taipei City (TW); Ming-Chien HO, Taipei City (TW); Chih-Fan HSU, Taipei City (TW); Ming-Ching CHANG, Taipei City (TW); Wei-Chao CHEN, Taipei City (TW); Feng-Hao LIU, Taipei City (TW); Yu HSIAO, Taipei City (TW); Shih-Hao HUNG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/319,452

(22) Filed: Sep. 4, 2025

(30) Foreign Application Priority Data
Mar. 12, 2025 (CN) 202510288477.2

(51) Int. Cl. H04L 9/40

(52) U.S. Cl. CPC H04L 63/0428; H04L 63/06

(57) ABSTRACT

A secure multi-party computation system and its operating method are proposed. The method includes: the first and second devices jointly perform linear operations in a neural network layer on input data to respectively generate intermediate results. The first and second devices merge noise into the respective intermediate results to generate a merged result, rearrange the plurality of elements according to a shuffle key to generate an obfuscated result. A third device performs a nonlinear operation in the neural network layer according to the obfuscated result to generate an output result, and splits the output result into a first output and a second output and transmitted to the first and second devices. The first and second devices extract the output data according to the shuffle key and store the output data in the first device.

### CROSS-REFERENCE TO RELATED APPLICATIONS

This non-provisional application claims priority under 35 U.S.C. § 119(a) on Patent Application No(s). 202510288477.2 filed in China on Mar. 12, 2025, the entire contents of which are hereby incorporated by reference.

### BACKGROUND

### 1. Technical Field

The present disclosure relates to secure multi-party computation and deep neural networks, and more particularly to a secure multi-party computation system and an operating method thereof.

### 2. Related Art

The computation of a deep neural network (DNN) can be divided into two parts: linear operations and nonlinear operations. In encrypted DNN inference techniques, commonly used methods include fully homomorphic encryption (FHE) and secure multi-party computation (MPC). These technologies have been successfully applied to perform inference in encrypted environments to protect sensitive information from being leaked.

However, the existing technologies face significant performance bottlenecks when handling nonlinear operations. Due to the extremely high computational cost of nonlinear operations (e.g., Softmax, GeLU, LayerNorm, ReLU, Batch Normalization) under FHE and MPC frameworks, the inference time increases significantly. For example, when performing Transformer inference in an MPC environment, nonlinear operations may account for the majority of total computation time. Similarly, in FHE-based ResNet inference, nonlinear operations also constitute the main computational burden. This indicates that although current DNN privacy-preserving technologies can ensure data security, they still suffer from inefficiencies when processing nonlinear operations, which limits their practical application.

### SUMMARY

In view of the above, the present disclosure proposes a secure multi-party computation system and an operating method thereof to address the aforementioned problems.

According to one or more embodiment of the present disclosure, an operating method of secure multi-party computation system includes: jointly performing, by a first device and a second device, a linear operation in a neural network layer on input data to respectively generate intermediate results, wherein the input data is stored in the first device, and a model corresponding to the neural network layer is stored in the second device; merging, by the first device and the second device, noise into the respective intermediate results generated by the first device and the second device to generate a merged result comprising a plurality of elements; rearranging, by the first device and the second device, the plurality of elements according to a shuffle key to generate an obfuscated result and transmitting the obfuscated result to a third device; performing, by the third device, a nonlinear operation in the neural network layer according to the obfuscated result to generate an output result; splitting, by the third device, the output result into a first output and a second output, and transmitting the first output and the second output to the first device and the second device respectively; and extracting, by the first device and the second device, output data from the first output and the second output according to the shuffle key, and storing the output data in the first device.

According to one or more embodiment of the present disclosure, a secure multi-party computation system includes a first device, a second device, and a third device. The first device is configured to store input data and output data. The second device is communicatively connected to the first device and configured to store a model corresponding to a neural network layer. The first device and the second device are configured to jointly perform a linear operation in the neural network layer on the input data to respectively generate intermediate results, merge noise into the respective intermediate results to generate a merged result comprising a plurality of elements, rearrange the plurality of elements according to a shuffle key to generate and transmit an obfuscated result. The third device is communicatively connected to the first device and the second device, and configured to perform a nonlinear operation in the neural network layer according to the obfuscated result to generate an output result, split the output result into a first output and a second output and transmit the first output and the second output to the first device and the second device respectively. The first device and the second device are further configured to extract the output data from the first output and the second output according to the shuffle key and store the output data in the first device.

In summary, the secure multi-party computation system and operating method proposed in the present disclosure construct an innovative Trusted Computing Framework (TCF). This framework integrates differential privacy techniques and multi-party computation methods to provide security assurance during the inference and training processes of deep neural networks. TCF effectively improves the efficiency of nonlinear computations and successfully reduces the time cost of relevant computations by more than 100 times, significantly enhancing processing speed and cost-effectiveness. It fully demonstrates the possibility of achieving both privacy protection and high-efficiency computation.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a secure multi-party computation system according to an embodiment of the present disclosure;

FIG. 2 is a flowchart illustrating an operating method of the secure multi-party computation system according to an embodiment of the present disclosure; and

FIG. 3 is a flowchart illustrating the operating method of the secure multi-party computation system according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

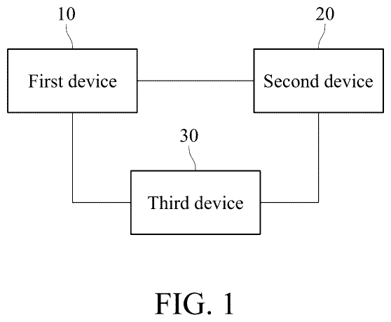

FIG. 1 is a block diagram of a secure multi-party computation system according to an embodiment of the present disclosure. As shown in FIG. 1, the secure multi-party computation system includes a first device 10, a second device 20, and a third device 30.

The first device 10 is configured to store input data and output data. The first device 10 is a hardware device that provides data, and users are allowed to access artificial intelligence (AI) services through the first device 10.

The second device 20 is communicatively connected to the first device 10 and is configured to store a model corresponding to a neural network layer. The second device 20 is a hardware device that provides AI services.

The third device 30 is communicatively connected to the first device 10 and the second device 20. The third device 30 serves as an auxiliary device responsible for assisting with nonlinear operations in the AI services. It should be noted that the third device 30 does not provide input nor receive output during computation. A key feature of the present disclosure is the introduction of the third device 30 to assist with nonlinear operations, thereby effectively protecting the input privacy of the first device 10 and the second device 20.

In an embodiment, the first device 10, the second device 20, and the third device 30 may each be implemented using at least one of the following: personal computer, network server, central processing unit (CPU), graphic processing unit (GPU), microcontroller (MCU), application processor (AP), field-programmable gate array (FPGA), application-specific integrated circuit (ASIC), system-on-a-chip (SoC), deep learning accelerator, or any other electronic device with similar functionality. The present disclosure does not limit the hardware types of the first device 10, the second device 20, and the third device 30.

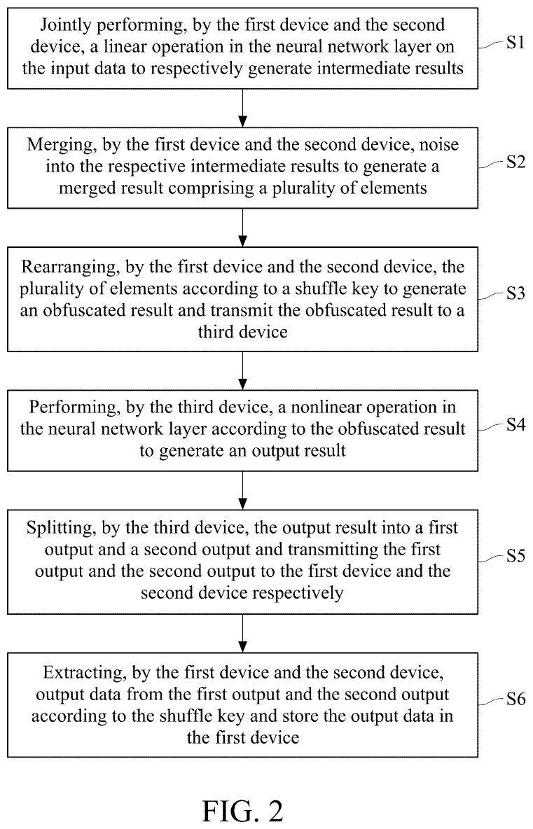

FIG. 2 is a flowchart illustrating an operating method of the secure multi-party computation system according to an embodiment of the present disclosure, including step S1 to step S6. In step S1, the first device 10 and the second device 20 jointly perform a linear operation in the neural network layer on the input data to respectively generate intermediate results, wherein the input data is stored in the first device 10 and the model corresponding to the neural network layer is stored in the second device 20. In step S2, the first device 10 and the second device 20 merge noise into the intermediate results to generate a merged result comprising a plurality of elements. In step S3, the first device 10 and the second device 20 rearrange the plurality of elements according to a shuffle key to generate an obfuscated result and transmit the obfuscated result to the third device 30. In step S4, the third device 30 performs a nonlinear operation in the neural network layer according to the obfuscated result to generate an output result. In step S5, the third device 30 splits the output result into a first output and a second output and transmits the first output and the second output to the first device 10 and the second device 20, respectively. In step S6, the first device 10 and the second device 20 extract output data from the first output and the second output according to the shuffle key and store the output data in the first device 10. The process shown in FIG. 2 is applicable to any layer of a neural network. Until the output layer is reached, the process returns to step S1 after completing step S6 to proceed with the next layer.

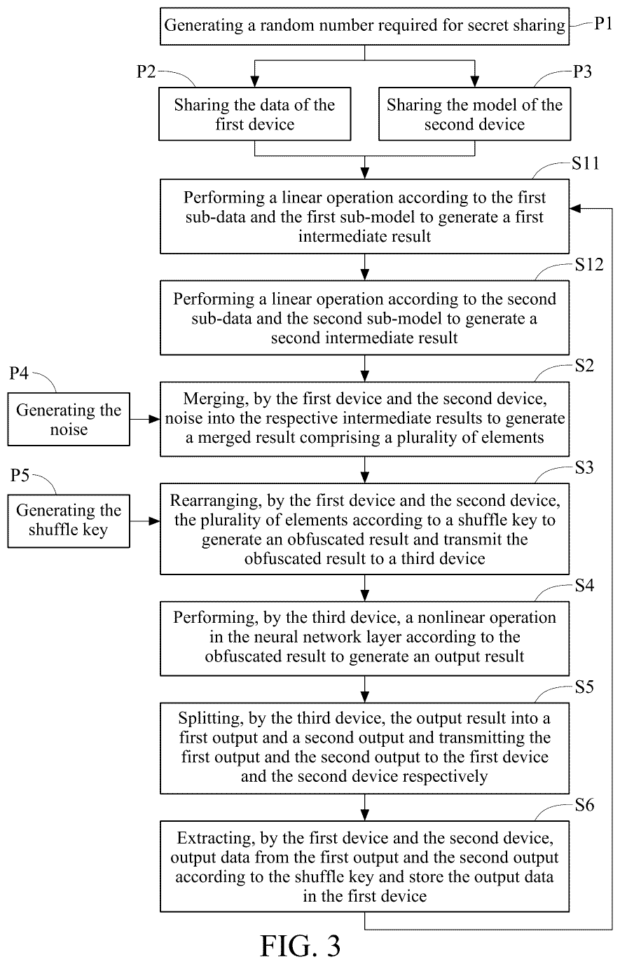

FIG. 3 is a flowchart illustrating the operating method of the secure multi-party computation system according to another embodiment of the present disclosure, including step P1 to step P5, step S11 to step S12, and step S2 to step S6, where step S11 and step S12 represent an implementation of step S1. Step S11 to step S12 and step S2 to step S6 belong to an online phase, while step P1 to step P4 belong to an offline phase and must be completed before the online phase.

Before the first device 10 and the second device 20 perform step S11 and step S12, step P1 to step P3 must be completed:

Step P1: Generate a random number required for secret sharing, such as Beaver triple. This is a multiplication protocol used in Secure Multi-Party Computation (MPC), and it is applied to the linear operations in step S1 and the nonlinear operations in step S6. Step P1 may be performed by the first device 10, the second device 20, or the third device 30.

In convolutional neural networks and fully connected neural networks, linear operations involve matrix computations between the model weights and either the input data or the output data from the previous neural network layer. In the Transformer architecture, in addition to matrix computations between the model weights and either the input data or the output data from the previous neural network layer, matrix computations are also performed on the intermediate generated data. In an embodiment, the present disclosure adopts Beaver protocol from MPC and matrix multiplication functions from Fully Homomorphic Encryption (FHE) schemes to implement these linear operations.

Step P2: Share the data of the first device 10. Specifically, the first device 10 splits the input data into a first sub-data and a second sub-data based on secret sharing, and transmits the second sub-data to the second device 20.

Step P3: Share the model of the second device 20. Specifically, the second device 20 splits the model into a first sub-model and a second sub-model based on secret sharing, and transmits the first sub-model to the first device 10.

In step S11, the first device 10 performs a linear operation according to the first sub-data and the first sub-model to generate a first intermediate result. In step S12, the second device 20 performs a linear operation according to the second sub-data and the second sub-model to generate a second intermediate result. The intermediate results mentioned in step S1 includes both the first intermediate result and the second intermediate result.

Before step S2 is performed by the first device 10 and the second device 20, step P4 and step P5 must be completed:

Step P4: Generate noise required for data obfuscation in step S3. Specifically, at least one of the first device 10 and the second device 20 jointly generates this noise according to a parameter. The parameter includes a mean, a variance, and a diffusion range of the noise, and the noise is generated using a Gaussian mechanism or a Laplace mechanism.

Step P5: Generate the shuffle key used in step S3 and step S6, by at least one of the first device 10 and the second device 20. The Fisher-Yates shuffle algorithm may be configured to generate the shuffle key.

In step S2 and step S3, the first device 10 and the second device 20 perform a Randomized Mechanism (RM) to obfuscate the data for privacy protection. First, the intermediate results of the linear operations are merged with noise. Then, according to the shuffle key, the elements within the merged result are randomly reordered to generate a new array. Specifically, the first device 10 merges the first intermediate result with noise to generate a first merged result; the second device 20 merges the second intermediate result with noise to generate a second merged result. The merged result mentioned in step S2 includes the first merged result and the second merged result. The first device 10 rearranges the plurality of elements of the first merged result according to the shuffle key to generate a first obfuscated result. The second device 20 rearranges the plurality of elements of the second merged result according to the shuffle key to generate a second obfuscated result. The obfuscated result mentioned in step S3 and step S4 include both the first obfuscated result and second obfuscated result.

In step S4, the third device 30 performs nonlinear operations on the obfuscated results, including but not limited to: ReLU, sorting, exponentiation, division, square root, and Softmax.

Overall, the secure multi-party computation system and its operating method proposed in the present disclosure construct an innovative Trusted Computing Framework (TCF). Tables 1 and 2 illustrate the notations and functions used in this framework. Specifically, the TCF includes three modules shown in Table 3 and eight basic protocols shown in Table 4.

TABLE 1
notation descriptions.

| Notation | Description |
|---|---|
| Π | Notation representing a multi-party |
| | computation protocol |
| [symbol] | Input data of the neural network layer |
| [symbol] | Output data of the neural network layer |
| [symbol] | Weight of the neural network layer |
| [symbol] | Parameter of the noise generator |
| [symbol] | Noise |
| [symbol] | Output of the randomization mechanism, |
| | i.e., the obfuscation result of step S3 |
| [symbol] | Output result of the nonlinear |
| | operation in step S4 |
| [symbol] · [symbol] | Secret sharing |
| [symbol] | Homomorphic encryption of [symbol] |
| [symbol] _{SS} | Key for encryption and decryption |
| | in secret sharing |
| [symbol] _{FHE} | Key for encryption and decryption in |
| | fully homomorphic encryption |
| [symbol] _{Sh} | Key for encryption and decryption |
| | in shuffle encryption |
| [symbol] | Homomorphic encryption after |
| | secret sharing of [symbol] |

TABLE 2
function descriptions

| Function | Description |
|---|---|
| SS. Enc( [symbol] ss, [symbol] ) → [symbol] | Secret sharing encryption function |
| SS. Dec( [symbol] ss, [symbol] ) → [symbol] | Secret sharing decryption function |
| FHE. Enc( [symbol] _{FHE}, [symbol] ) → [symbol] | Fully homomorphic encryption function |
| FHE. Dec( [symbol] _{FHE}, [symbol] ) → [symbol] | Fully homomorphic decryption function |
| GenNoise( [symbol] ) → [symbol] | Noise generator |
| Merge( [symbol] , [symbol] ) → [symbol] [( [symbol] ) [symbol] ] [symbol] | Merge [symbol] and [symbol] to get [symbol] [ [symbol] , [symbol] ] [symbol] |
| Shuffle( [symbol] [symbol] , [symbol] ] [symbol] , [symbol] _{Sh}) → [symbol] | Reorder [symbol] [symbol] , [symbol] ] [symbol] to get [symbol] |
| Extract( [symbol] , [symbol] _{Sh}) → [symbol] | Extract [symbol] from [symbol] and restore |
| | original order |
| ReLU( ) | Rectified Linear Unit |
| Sort( ) | Sorting operation |
| Exp( ) | Exponential function |
| Div( ) | Normalized division |
| Sqrt( ) | Square root |

TABLE 3
online modules

| Module | Description |
|---|---|
| Linear operation | The first device 10 and the second |
| | device 20 jointly execute Π_{MatMul}. |
| Randomized | The first device 10 and the second |
| mechanism | device 20 jointly execute Π_{RM}. |
| Nonlinear | The second device 20 performs |
| operation | the nonlinear operations on the |
| | obfuscated result output by Π_{RM}, |
| | including ReLU( ), Sort( ), Exp( ), |
| | Div( ), and Sqrt( ). |

TABLE 4
basic protocols

| Protocol | Notation | Input | Output |
|---|---|---|---|
| Linear operation | Π_{MatMul} | ( [symbol] , [symbol] [symbol] [symbol] ) | [symbol] [symbol] · [symbol] [symbol] |
| Randomized mechanism | Π_{RM} | [symbol] | [symbol] |
| ReLU( ) | Π_{Relu} | [symbol] x [symbol] | [symbol] Relu(x) [symbol] |
| Sort( ) | Π_{Sort} | [symbol] [symbol] [symbol] | [symbol] Sort( [symbol] ) [symbol] |
| Exp( ) | Π_{Exp} | [symbol] x [symbol] | [symbol] e^{x} [symbol] |
| Div( ) | Π_{Div} | [symbol] x [symbol] | $〚 \frac{1}{x} 〛$ |
| Sqrt( ) | Π_{Sqrt} | [symbol] x [symbol] | [symbol] \sqrt{x} [symbol] |
| Softmax | Π_{Smax} | [symbol] x [symbol] | [symbol] Softmax(x) [symbol] |

Based on the notations and functions defined in the tables above, the following describes implementation examples of various nonlinear operations.

$${Π}_{Relu} , \qquad Example 1$$

$${Π}_{Sort} ,$$

$${Π}_{Exp} ,$$

$${Π}_{Div} ,$$

$${Π}_{Sqrt}$$

1. The first device 10 and the second device 20 jointly execute GenNoise( [symbol] )→ [symbol] .
2. The first device 10 and the second device 20 jointly execute Merge( [symbol] , [symbol] )→ [symbol] ( [symbol] )\vec{η} [symbol] .
3. The first device 10 and the second device 20 jointly execute Shuffle( [symbol] [( [symbol] · [symbol] , [symbol] _{Sh})→ [symbol] .
4. The first device 10 and the second device 20 jointly transmit [symbol] to the third device 30.
5. The third device 30 executes ReLU/Sort/Exp/Div/Sqrt( [symbol] )→ [symbol] .
6. The third device 30 splits [symbol] and transmits the split result to the first device 10 and the second device 20.
7. The first device 10 and the second device 20 jointly execute Extract( [symbol] ,\vec{k}ₛₕ)→ [symbol] \vec{y} [symbol] .

In Example 2, Π_{Smax} includes the following three implementations:

First implementation:
1. The first device 10, the second device 20, and the third device 30 jointly execute Π_{Exp}( [symbol] )→ [symbol] .
2. The first device 10 and the second device 20 jointly execute Π_{MatMul}( [symbol] \vec{e} [symbol] )→ [symbol] m [symbol] ; specifically, this computes the sum of all elements in \vec{e}.
3. The first device 10 and the second device 20 jointly execute [symbol] m [symbol] + [symbol] ϵ [symbol] = [symbol] m+ϵ [symbol] , where ϵ is a random integer used as a mask.
4. The first device 10 and the second device 20 transmit [symbol] m+ϵ [symbol] to the third device 30.
5. The third device 30 executes SS.Dec( [symbol] _{SS}, [symbol] m+ϵ [symbol] →d, where d is the plaintext with the mask applied.
6. The third device 30 executes d+λ, where λ is a random integer used as noise.
7. The third device 30 transmits d+λ to the first device 10 and the second device 20.
8. The first device 10 and the second device 20 remove the mask ϵ from d+λ to obtain m+λ.
9. The first device 10 and the second device 20 jointly execute

$${Π}_{MatMul} ( [ [ \vec{e} ] ] , [ [ m + λ ] ] ) \to [ [ \frac{\vec{e}}{m + λ} ] ] .$$

Second implementation:
1. The first device 10, the second device 20, and the third device 30 jointly execute Π_{Exp}( [symbol] )→ [symbol] .
2. The first device 10 and the second device 20 jointly execute Π_{MatMul}( [symbol] )→ [symbol] .
3. The first device 10, the second device 20, and the third device 30 jointly execute Π_{Div}( [symbol] )→ [symbol] .
4. The first device 10 and the second device 20 jointly execute Π_{MatMul}( [symbol] , [symbol] )→ [symbol] .

### Third Implementation:

1. The first device 10, the second device 20, and the third device 30 jointly execute Π_{Exp}( [symbol] )→ [symbol] .
2. The first device 10 and the second device 20 jointly execute Π_{MatMul}( [symbol] )→ [symbol] .
3. The first device 10 and the second device 20 jointly execute FHE.Enc( [symbol] _{FHE}, [symbol] )→ [symbol] .
4. The first device 10 and the second device 20 transmit [symbol] to the third device 30.
5. The second device 20 performs \hat{m}+\hat{λ}.
6. The second device 20 transmits \hat{m}+\hat{λ} to the first device 10 and the second device 20.
7. The first device 10 and the second device 20 jointly execute FHE.Dec( [symbol] _{FHE},\hat{m}+\hat{λ})→m+λ.
8. The first device 10 and the second device 20 jointly execute

$${Π}_{MatMul} ( [ [ \vec{e} ] ] ) \to [ [ \frac{\vec{e}}{m + λ} ] ] .$$

TABLE 5
protocol of TCF-based convolutional neural network model

| Protocol | Notation | Input | Output |
|---|---|---|---|
| Input layer | Π_{L} | ( [symbol] , [symbol] ) | [symbol] Relu( [symbol] ) [symbol] |
| Hidden layer | Π_{HL} | ( [symbol] , [symbol] ) | [symbol] Relu( [symbol] ) [symbol] |
| Output layer | Π_{OL} | ( [symbol] , [symbol] ) | [symbol] Sort( [symbol] ) [symbol] |

As shown in Table 5, common neural networks such as convolutional neural networks and fully connected neural networks may be implemented using the modules and protocols proposed in Tables 3 and 4. Specifically, examples of the input layer Π_{IL} and the hidden layer Π_{HL} are as follows:
1. The first device 10 and the second device 20 jointly execute Π_{MatMul}( [symbol] , [symbol] )→ [symbol] .
2. The first device 10, the second device 20, and the third device 30 jointly execute Π_{ReLU}( [symbol] )→ [symbol] .

An example implementation of the output layer Π_{OL} is as follows:
1. The first device 10 and the second device 20 jointly execute Π_{MatMul}( [symbol] , [symbol] )→ [symbol] .
2. The first device 10, the second device 20, and the third device 30 jointly execute Π_{Sort}( [symbol] )→ [symbol] .

TABLE 6
protocol of transformer model based on TCF

| Protocol | Notation | Input | Output |
|---|---|---|---|
| Attention layer | Π_{AL} | ( [symbol] , [symbol] , [symbol] , [symbol] ) | $〚 softmax ( \frac{( \vec{x} \cdot {\vec{w}}_{q} ) {( \vec{x} \cdot {\vec{w}}_{K} )}^{T}}{\sqrt{{d}_{k}}} ) ( \vec{x} \cdot {\vec{w}}_{V} ) 〛$ |

As shown in Table 6, the attention layer in common Transformer neural networks may be implemented using the modules and protocols proposed in Tables 3 and 4, as follows:
1. The first device 10 and the second device 20 jointly execute Π_{MatMul}( [symbol] , [symbol] )→ [symbol] .
2. The first device 10 and the second device 20 jointly execute Π_{MatMul}( [symbol] , [symbol] )→ [symbol] .
3. The first device 10 and the second device 20 jointly execute Π_{MatMul}( [symbol] , [symbol] )→ [symbol] .
4. The first device 10 and the second device 20 jointly execute Π_{MatMul}( [symbol] · [symbol] , [symbol] · [symbol] )→ [symbol] ( [symbol] )·( [symbol] )^{T} [symbol] .
5. The first device 10, the second device 20, and the third device 30 jointly execute Π_{Smax}( [symbol] ( [symbol] )·( [symbol] )^{T} [symbol] )→ [symbol] .
6. The first device 10 and the second device 20 jointly execute Π_{MatMul}( [symbol] , [symbol] · [symbol] )→ [symbol] ·( [symbol] ) [symbol] .

TABLE 7
below shows a comparison of the runtime
performance between the present
disclosure and conventional techniques. The testing
environment is configured as follows:
CIFAR-10 dataset, 6-layer CNN, and AMD
Ryzen Threadripper PRO 5975WX CPU.

| | | | TCF-DNN | |
|---|---|---|---|---|
| | | | (The present | |
| | FHE-DNN | MPC-DNN | disclosure) | Baseline |
| Total Time | 540 s | 38.4804 s | 0.6453 s | 0.0372 s |
| | (64-thread) | | (1-thread) | (1-thread) |
| Linear function | 27 s | 0.3255 s | 0.3177 s | |
| computation time | | (1-thread) | | |
| Nonlinear function | 513 s | 38.1549 s | 0.3276 s | |
| computation time | | (~5-thread) | | |

In summary, the secure multi-party computation system and operating method proposed in the present disclosure construct an innovative Trusted Computing Framework (TCF). This framework integrates differential privacy techniques and multi-party computation methods to provide security assurance during the inference and training processes of deep neural networks. TCF effectively improves the efficiency of nonlinear computations and successfully reduces the time cost of relevant computations by more than 100 times, significantly enhancing processing speed and cost-effectiveness. It fully demonstrates the possibility of achieving both privacy protection and high-efficiency computation.

What is claimed is:

1. An operating method of secure multi-party computation system, comprising:
jointly performing, by a first device and a second device, a linear operation in a neural network layer on input data to respectively generate intermediate results, wherein the input data is stored in the first device, and a model corresponding to the neural network layer is stored in the second device;
merging, by the first device and the second device, noise into the respective intermediate results generated by the first device and the second device to generate a merged result comprising a plurality of elements;
rearranging, by the first device and the second device, the plurality of elements according to a shuffle key to generate an obfuscated result and transmitting the obfuscated result to a third device;
performing, by the third device, a nonlinear operation in the neural network layer according to the obfuscated result to generate an output result;
splitting, by the third device, the output result into a first output and a second output, and transmitting the first output and the second output to the first device and the second device respectively; and
extracting, by the first device and the second device, output data from the first output and the second output according to the shuffle key, and storing the output data in the first device.

2. The operating method of secure multi-party computation system of claim 1, further comprising:
splitting, by the first device, the input data into first sub-data and second sub-data, and transmitting the second sub-data to the second device; and
splitting, by the second device, the model into a first sub-model and a second sub-model, and transmitting the first sub-model to the first device;
wherein jointly performing, by the first device and the second device, the linear operation in the neural network layer on the input data to respectively generate the intermediate results comprises:
performing, by the first device, the linear operation according to the first sub-data and the first sub-model to generate a first intermediate result; and
performing, by the second device, the linear operation according to the second sub-data and the second sub-model to generate a second intermediate result.

3. The operating method of secure multi-party computation system of claim 1, further comprising:
jointly generating, by at least one of the first device and the second device, the noise according to a parameter, wherein the parameter comprises at least one of a mean, a variance, and a diffusion range of the noise, and the noise is generated using a Gaussian mechanism or a Laplace mechanism.

4. The operating method of secure multi-party computation system of claim 1, further comprising:
generating, by at least one of the first device and the second device, a Beaver triple for the linear operation.

5. A secure multi-party computation system, comprising:
a first device configured to store input data and output data;
a second device communicatively connected to the first device and configured to store a model corresponding to a neural network layer, wherein the first device and the second device are configured to jointly perform a linear operation in the neural network layer on the input data to respectively generate intermediate results, merge noise into the respective intermediate results to generate a merged result comprising a plurality of elements, rearrange the plurality of elements according to a shuffle key to generate and transmit an obfuscated result; and
a third device communicatively connected to the first device and the second device, and configured to perform a nonlinear operation in the neural network layer according to the obfuscated result to generate an output result, split the output result into a first output and a second output and transmit the first output and the second output to the first device and the second device respectively, wherein the first device and the second device are further configured to extract the output data from the first output and the second output according to the shuffle key and store the output data in the first device.

6. The secure multi-party computation system of claim 5, wherein the first device is further configured to split the input data into a first sub-data and a second sub-data and transmit the second sub-data to the second device, the second device is further configured to split the model into a first sub-model and a second sub-model and transmit the first sub-model to the first device, and jointly performing the linear operation in the neural network layer by the first device and the second device to respectively generate the intermediate results comprises: performing, by the first device, the linear operation according to the first sub-data and the first sub-model to generate a first intermediate result; and performing, by the second device, the linear operation according to the second sub-data and the second sub-model to generate a second intermediate result.

7. The secure multi-party computation system of claim 5, wherein at least one of the first device and the second device is further configured to jointly generate the noise according to a parameter, wherein the parameter comprises at least one of a mean, a variance, and a diffusion range of the noise, and the noise is generated using a Gaussian mechanism or a Laplace mechanism.

8. The secure multi-party computation system of claim 5, wherein at least one of the first device and the second device is further configured to generate a Beaver triple for the linear operation.
